(19) United States
(12) Patent Application Publication
(10) Pub. No.: US 2009/0036144 A1
(43) Pub. Date: Feb. 5, 2009

(54) TECHNIQUES FOR MOBILITY INDUCED ERROR CORRECTION

(76) Inventors: Wendy C. Wong, San Jose, CA (US); Timothy F. Cox, Palo Alto, CA (US)

Correspondence Address: KACVINSKY LLC;C/O INTELLEVATE, P.O. BOX 52050, MINNEAPOLIS, MN, 55402, US

(21) Appl. No.: 11/830,907

(22) Filed: Jul. 31, 2007

(51) Int. Cl. H04Q 7/20

(52) U.S. Cl. 455/456.3

(57) ABSTRACT

Techniques for mobility induced error correction are described. An apparatus may comprise a mobile device having a frequency correction module arranged to determine a frequency shift for a communication channel caused by movement of the mobile device relative to a fixed device, and generate a frequency correction value to compensate for the frequency shift. Other embodiments are described and claimed.

### BACKGROUND

A mobile device such as a cellular telephone typically communicates with a fixed device such as a base station over a portion of radio-frequency (RF) spectrum. For example, the mobile device and fixed device communicate over one or more RF communication channels. In some cases, however, the mobile device may be moving fast enough to cause a frequency shift in the communications frequencies used for the communication channels. Left uncorrected, the frequency shift may degrade communications between the fixed device and mobile device. In an extreme case the frequency shift my cause the communication channel to disconnect or drop entirely. Consequently, there may be a substantial need in compensating for frequency shifts due to mobility issues.

### BRIEF DESCRIPTION OF THE DRAWINGS

FIG. 1 illustrates one embodiment of a communication system.

FIG. 2 illustrates one embodiment of an apparatus.

FIG. 3 illustrates one embodiment of a logic diagram.

FIG. 4 illustrates one embodiment of a logic flow.

### DETAILED DESCRIPTION

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to communication techniques for a wireless communications network, such as a mobile broadband communications system. Some embodiments may be particularly directed to techniques for correcting, compensating or otherwise mitigating mobility induced frequency shifts, such as Doppler effects. In one embodiment, for example, a mobile device such as a cellular telephone may include a frequency correction module. The frequency correction module may be arranged to determine a frequency shift for a communication channel caused by movement of the mobile device relative to a fixed device. An example of a fixed device may comprise fixed equipment for a cellular radiotelephone system, such as a base station or node B. The frequency correction module may generate a frequency correction value to compensate for the frequency shift. In this manner, the frequency correction module may reduce or eliminate the effects of Doppler frequency shifts and ensures good signal quality, enabling high mobile velocity and supporting higher data rates for a mobile broadband communication system. Other embodiments may be described and claimed.

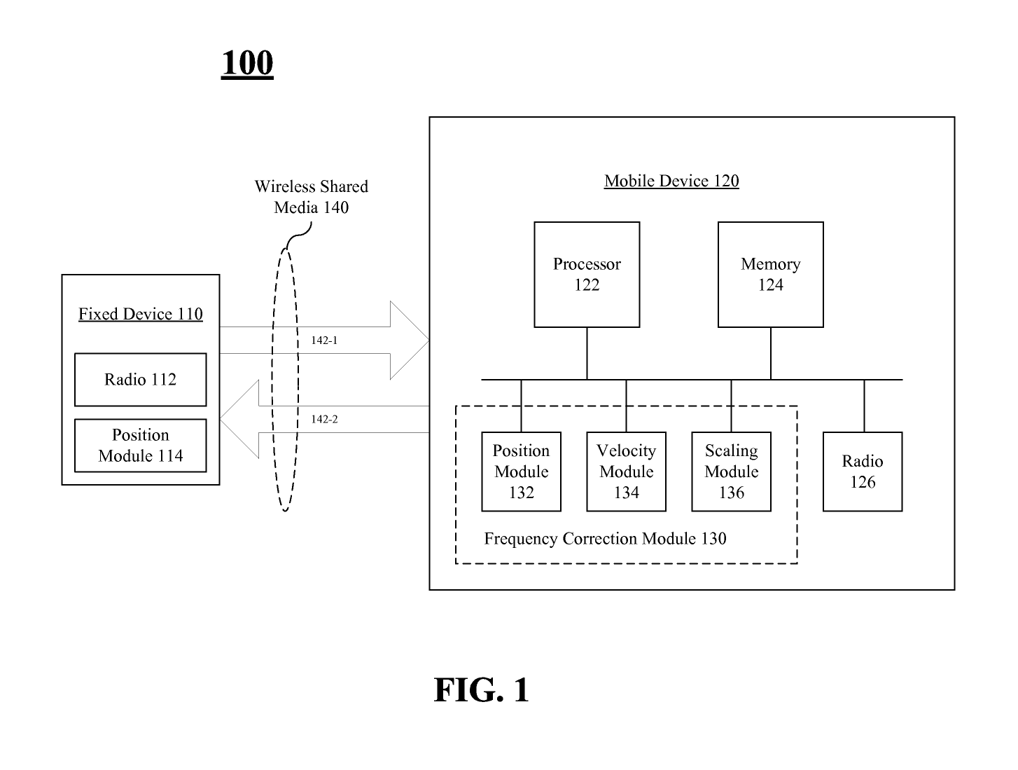

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links, such as wireless shared media 140. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands. In the latter case, the wireless nodes may include one more wireless interfaces and/or components for wireless communication, such as one or more radios, transmitters, receivers, transceivers, chipsets, amplifiers, filters, control logic, network interface cards (NICs), antennas, antenna arrays, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth. In one embodiment, certain devices may include antenna arrays of multiple antennas to implement various adaptive antenna techniques and spatial diversity techniques.

As shown in the illustrated embodiment of FIG. 1, the communication system 100 comprises multiple elements, such as a fixed device 110 and a mobile device 120, both of which communicate via wireless shared media 140. The fixed device may further include a radio 112 and a position module 114. The mobile device 120 may further include a processor 122, a memory unit 124, a frequency correction module 130, and a radio 126. The frequency correction module 130 may further include a position module 132, a velocity module 134 and a scaling module 136. The embodiments, however, are not limited to the elements shown in this figure.

In various embodiments, the communications system 100 may comprise or be implemented as a mobile broadband communications system. Examples of mobile broadband communications systems include without limitation systems compliant with various Institute of Electrical and Electronics Engineers (IEEE) standards, such as the IEEE 802.11 standards for Wireless Local Area Networks (WLANs) and variants, the IEEE 802.16 standards for Wireless Metropolitan Area Networks (WMANs) and variants, and the IEEE 802.20 or Mobile Broadband Wireless Access (MBWA) standards and variants, among others. In one embodiment, for example, the communications system 100 may be implemented in accordance with the Worldwide Interoperability for Microwave Access (WiMAX) or WiMAX II standard. WiMAX is a wireless broadband technology based on the IEEE 802.16 standard of which IEEE 802.16-2004 and the 802.16e amendment (802.16e-2005) are Physical (PHY) layer specifications. WiMAX II is an advanced Fourth Generation (4G) system based on the IEEE 802.16j and IEEE 802.16m proposed standards for International Mobile Telecommunications (IMT) Advanced 4G series of standards. Although some embodiments may describe the communications system 100 as a WiMAX or WiMAX II system or standards by way of example and not limitation, it may be appreciated that the communications system 100 may be implemented as various other types of mobile broadband communications systems and standards, such as a Universal Mobile Telecommunications System (UMTS) system series of standards and variants, a Code Division Multiple Access (CDMA) 2000 system series of standards and variants (e.g., CDMA2000 1xRTT, CDMA2000 EV-DO, CDMA EV-DV, and so forth), a High Performance Radio Metropolitan Area Network (HIPERMAN) system series of standards as created by the European Telecommunications Standards Institute (ETSI) Broadband Radio Access Networks (BRAN) and variants, a Wireless Broadband (WiBro) system series of standards and variants, a Global System for Mobile communications (GSM) with General Packet Radio Service (GPRS) system (GSM/GPRS) series of standards and variants, an Enhanced Data Rates for Global Evolution (EDGE) system series of standards and variants, a High Speed Downlink Packet Access (HSDPA) system series of standards and variants, a High Speed Orthogonal Frequency-Division Multiplexing (OFDM) Packet Access (HSOPA) system series of standards and variants, a High-Speed Uplink Packet Access (HSUPA) system series of standards and variants, and so forth. The embodiments are not limited in this context.

In various embodiments, the communication system 100 may comprise a fixed device 110 having wireless capabilities. A fixed device may comprise a generalized equipment set providing connectivity, management, or control of another wireless device, such as one or more mobile devices. Examples for the fixed device 110 may include a wireless access point (AP), base station or node B, router, switch, hub, gateway, and so forth. In one embodiment, for example, the fixed device may comprise a base station or node B for a cellular radiotelephone system or mobile broadband communications system. The fixed device 110 may also provide access to a network (not shown). The network may comprise, for example, a packet network such as the Internet, a corporate or enterprise network, a voice network such as the Public Switched Telephone Network (PSTN), and so forth. Although some embodiments may be described with the fixed device 110 implemented as a base station or node B by way of example, it may be appreciated that other embodiments may be implemented using other wireless devices as well. The embodiments are not limited in this context.

In some embodiments, the fixed device 110 may include a position module 114. The position module 114 may be arranged to retrieve, generate or provide fixed device position information for the fixed device 110. For example, during installation the position module 114 may be provisioned or programmed with position information for the fixed device 110 sufficient to locate a physical or geographic position for the fixed device 110. The fixed device position information may comprise information from a geographic coordinate system that enables every location on the earth to be specified by the three coordinates of a spherical coordinate system aligned with the spin axis of the Earth. For example, the fixed device position information may comprise longitude information, latitude information, and/or elevation information. In some cases, the position module 114 may implement a location determining technique or system for identifying a current location or position for the fixed device 110. In such cases, the position module 114 may comprise, for example, a Global Positioning System (GPS), a cellular triangulation system, and other satellite based navigation systems or terrestrial based location determining systems. This may be useful, for example, for automatically provisioning the fixed device 110 during installation, or when the fixed device 110 needs to be moved or relocated.

In various embodiments, the communication system 100 may comprise a mobile device 120 having wireless capabilities. The mobile device 120 may comprise a generalized equipment set providing connectivity to other wireless devices, such as other mobile devices or fixed devices (e.g., fixed device 110). Examples for the mobile device 120 may include without limitation a computer, server, workstation, notebook computer, handheld computer, telephone, cellular telephone, personal digital assistant (PDA), combination cellular telephone and PDA, and so forth. In one embodiment, for example, the mobile device 120 may be implemented as mobile subscriber stations (MSS) for a WMAN. Although some embodiments may be described with the mobile device 120 implemented as a MSS by way of example, it may be appreciated that other embodiments may be implemented using other wireless devices as well. The embodiments are not limited in this context.

As shown in FIG. 1, the mobile device 120 may comprise a processor 122. The processor 122 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processor 122 may be implemented as a general purpose processor, such as a processor made by Intel® Corporation, Santa Clara, Calif. The processor 122 may also be implemented as a dedicated processor, such as a controller, microcontroller, embedded processor, a digital signal processor (DSP), a network processor, a media processor, an input/output (I/O) processor, and so forth. The embodiments are not limited in this context.

As further shown in FIG. 1, the mobile device 120 may comprise a memory unit 124. The memory 124 may comprise any machine-readable or computer-readable media capable of storing data, including both volatile and non-volatile memory. For example, the memory 124 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of the memory 124 may be included on the same integrated circuit as the processor 122, or alternatively some portion or all of the memory 124 may be disposed on an integrated circuit or other medium, for example a hard disk drive, that is external to the integrated circuit of the processor 122. The embodiments are not limited in this context.

In various embodiments, the devices 110, 120 may communicate information over wireless shared media 140 via respective radios 112, 126. The wireless shared media 140 may comprise one or more allocations of RF spectrum. The allocations of RF spectrum may be contiguous or non-contiguous. In some embodiments, the radios 112, 126 may communicate information over the wireless shared media 140 using various multicarrier techniques utilized by, for example, WiMAX or WiMAX II systems. For example, the radios 112, 126 may utilize various Multiple-Input Multiple-Output (MIMO) techniques to perform beam forming, spatial diversity or frequency diversity.

In general operation, the radios 112, 126 may communicate information using one or more communications channels, such as communications channels 142-1-m. A communication channel may be defined set of frequencies, time slots, codes, or combinations thereof. In one embodiment, for example, the transmitting portion of the radio 112 of the fixed device 110 may communicate media and control information to the receiving portion of the radio 126 of the mobile device 120 using the communications channel 142-1, sometimes referred to as a “downlink channel.” In one embodiment, for example, the transmitting portion of the radio 126 of the mobile device 110 may communicate media and control information to the receiving portion of the radio 112 of the fixed device 110 using the communications channel 142-2, sometimes referred to as an “uplink channel.” In some cases, the communications channels 142-1, 142-2 may use the same or different set of transmit and/or receive frequencies, depending upon a given implementation.

Since the communications system 100 is a mobile broadband communications system, it is designed to maintain communications operations even when the mobile device 120 is moving. Slower movement of the mobile device 120, such as when an operator is walking, causes relatively minor degradation of communications signals due to the actual movement and is easily corrected. Faster movement of the mobile device 120, such as when an operator is in a moving vehicle, however, may cause major degradation of communications signals due to frequency shifts. An example of such frequency shifts may be Doppler frequency shifts caused by the Doppler effect. The Doppler effect, named after Christian Doppler, is the change in frequency and wavelength of a wave as perceived by an observer moving relative to the source of the waves. For waves that propagate in a wave medium, such as sound waves, the velocity of the observer and of the source are reckoned relative to the medium in which the waves are transmitted. The total Doppler effect may therefore result from either motion of the source or motion of the observer, which in this case would be movement by the mobile device 120. As the mobile device 120 moves its velocity relative to the fixed device 110 induces a Doppler shift of the transmit RF signal used by the fixed device 110 as received by the mobile device 120. The received signal is used by the mobile device 120 to derive its own transmit RF signal. If uncorrected for the Doppler shift, the transmit RF signal used by the mobile device 120 would arrive at the fixed device 110 with twice the Doppler error, with the first from the downlink channel 142-1 and the second from the uplink channel 142-2. This is the reason why cellular telephone users sometimes experience dropped calls while in moving vehicles. Right before the call drops, the user typically can hear the other speaker on the downlink channel, but the other speaker cannot hear the user on the uplink channel.

Conventional mobile devices do not incorporate any internal frequency reference based Doppler compensation. The WiMAX standards do have some provisions that would enable a fixed device (e.g., a base station) to report a frequency offset from the received mobile device RF signal that it can then communicate to the mobile device to be incorporated into its frequency control. With a relatively large frequency shift caused by Doppler, however, the fixed device may not be able to measure the mobile device frequency shift and report it back to the mobile device for correction. Hence, this feedback mechanism may not be usable in this case.

To solve these and other problems, various embodiments incorporates positioning data into the RF control of the mobile device 120 to mitigate the deleterious effects of transmit RF signal frequency offset due to Doppler shift. The various embodiments use positioning data to determine the relative velocity of the mobile device 120 with respect to the fixed device 110, converts the relative velocity to a corresponding RF error correction value, and applies the derived error correction value to the mobile device 120 transmit RF signal. In the illustrated embodiment of FIG. 1, the error correction due to mobility induced errors may be implemented by the frequency correction module 130. As a result of implementing error correction techniques in the mobile device 120, the frequency correction module 130 of the mobile device 120 provides improved Doppler correction by the mobile device 120 while enabling the fixed device to make further frequency corrections by reducing the frequency error of the uplink signal transmitted by the mobile device 120.

In one embodiment, for example, the mobile device 120 may include a frequency correction module 130. The frequency correction module 130 may be arranged to determine a frequency shift for a communication channel caused by movement of the mobile device 120 relative to the fixed device 110. The frequency correction module 130 may generate a frequency correction value to compensate for the frequency shift. In this manner, the frequency correction module 130 may reduce or eliminate the effect of Doppler frequency shift and ensures good signal quality, thereby enabling high mobile velocity and supporting high data rates at the same time in a mobile broadband communication system such as the communications system 100.

In one embodiment, for example, the frequency correction module 130 may include a position module 132. Similar to the position module 114, the position module 132 may be arranged to generate mobile device position information for the mobile device 120. For example, the position module 132 may implement a location determining technique or system for identifying a current location or position for the mobile device 120. The position module 132 may comprise, for example, a GPS system, a cellular triangulation system, and other satellite based navigation systems or terrestrial based location determining systems. The mobile device position information may comprise information from a geographic coordinate system that enables every location on the earth to be specified by the three coordinates of a spherical coordinate system aligned with the spin axis of the Earth. For example, the mobile device position information may comprise longitude information, latitude information, and/or elevation information. The embodiments, however, are not limited in this context.

In one embodiment, for example, the frequency correction module 130 may include a velocity module 134. The velocity module 134 may implement a velocity determining technique or system for identifying a relative velocity for the mobile device 120. The velocity module 134 may identify the relatively velocity using mobile device position information for the mobile device 120 as generated by the position module 132, and fixed device position information for the fixed device 110 as generated by the position module 114. The velocity module 134 may be arranged to receive fixed device position information for the fixed device 110 and mobile device position information for the mobile device 120, and determine a relative velocity for the mobile device 120 using the fixed device position information and the mobile device position information.

In one embodiment, for example, the frequency correction module 130 may include a scaling module 136. The scaling module 136 may be arranged to receive a relative velocity value from the velocity module 134. The scaling module 136 may use the received relative velocity value to generate a frequency correction value for the transmit signal used by the radio 126 of the mobile device 120 as it transmits or sends information to the fixed device 110.

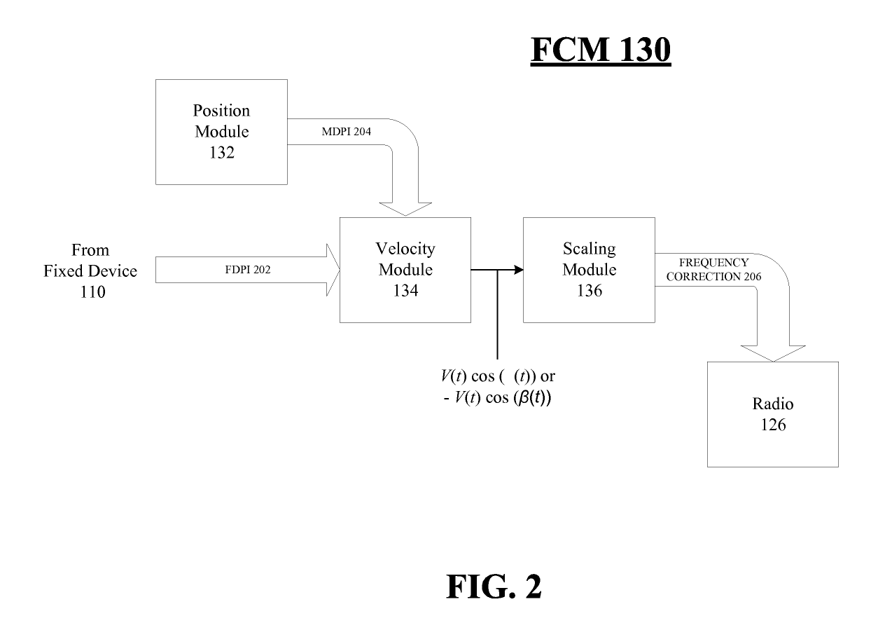

FIG. 2 illustrates one embodiment of an apparatus. FIG. 2 illustrates a more detailed block diagram for the frequency correction module 130. More particularly, FIG. 2 illustrates the processing of the positioning data at the mobile device 120, the combined calculation of the Doppler error from the fixed device position information and the mobile device position information, and the application of the error compensation to the transmit signal of the mobile device 120. The frequency correction module 130 may perform frequency correction at the radio 126 of the mobile device 120 to remove the Doppler induced error on transmissions over the uplink channel 142-2 from the mobile device 120 to the fixed device 110. For example, the radio 126 may communicate information from the mobile device 120 to the fixed device 110 over a transmit frequency produced by subtracting the frequency correction value from a receive frequency for the downlink channel 142-1. In some embodiments, the radio 126 may communicate information from the mobile device 120 to the fixed device 110 over a transmit frequency produced by subtracting two times the frequency correction value from a receive frequency for the downlink channel 142-1.

By way of a general example for a Time Division Duplexing (TDD) system, assume the fixed device 110 transmits signals over the downlink channel 142-1 on a RF frequency of f₁. As the mobile device 120 moves towards the fixed device 110, the fixed device 110 experiences a Doppler induced frequency shift of M_{F}(t) at time t. After receiving the downlink signal from the fixed device 110, the mobile device 120 now detects that the fixed device transmit frequency is at f₁+M_{F}(t). Without implementing mobility induced error correction and instead using conventional frequency pre-correction method for the uplink, however, the mobile device 120 will use an uplink transmit frequency of f₁+M_{F}(t). If left uncorrected, the uplink transmission from the mobile device 120 to the fixed device 110 over the uplink channel 142-2 will experience another Doppler frequency shift of M_{F}(t) so that the final uplink signal received at the fixed device 110 will be at a frequency of:

f₁+M_{F}(t)+M_{F}(t)=f₁+2M_{F}(t).

If the frequency correction module 130 of the mobile device 120 calculates the Doppler frequency shift M_{F}(t), however, then the correct channel frequency can be determined as f₁ and not f₁+M_{F}(t). In compensating for this Doppler induced error, the mobile device 120 will subtract 2 M_{F}(t) from the received downlink RF frequency f₁+M_{F}(t), thereby producing a pre-corrected Uplink transmit frequency of f₁−M_{F}(t). In transmission, this uplink signal from the mobile device 120 to the fixed device 110 will experience another Doppler frequency shift of M_{F}(t) so that the final signal received at the BS will be at frequency f₁−M_{F}(t)+M_{F}(t)=F₁, which is at the correct channel frequency expected at the fixed device 110. For Frequency Division Duplexing (FDD) systems, the uplink transmit frequency will be at

$${f}_{2} - {M}_{F} ( t ) \cdot \frac{{f}_{2}}{{f}_{1}}$$

where f₂ is the uplink RF frequency.

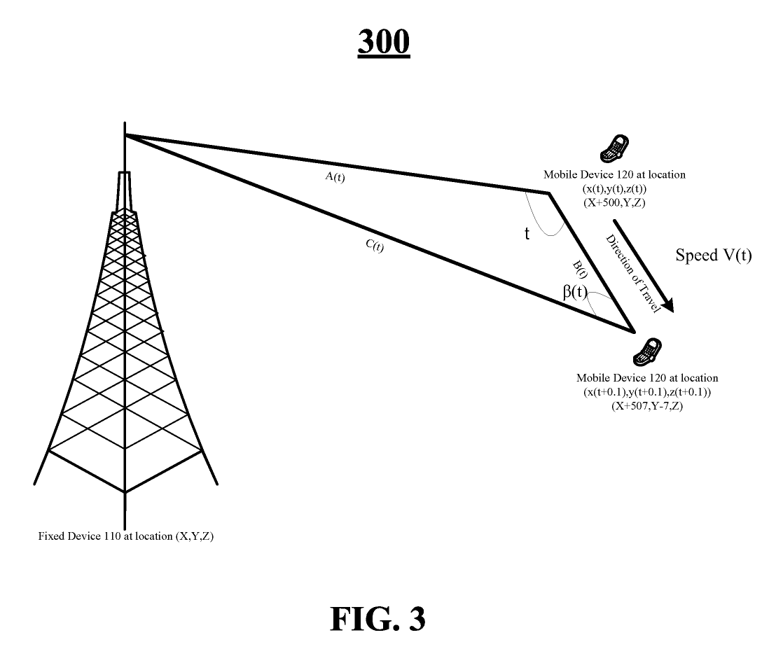

To perform frequency correction operations, the velocity module 134 may calculate a relative velocity V(t)φ(φ(t)) or −V(t)cos(β(t)) for the mobile device 120 as it moves within transmission range of a cell covered by the fixed device 110. The velocity module 134 may receive fixed device position information 202 from the fixed device 110, or another source such as a table or database stored in memory 124 of the mobile device 120, for example. The velocity module 134 may receive mobile device position information 204 from the position module 132 of the frequency correction module 130 implemented by the mobile device 120. The velocity module 134 may calculate the relative velocity V(t)cos(φ(t)) or −V(t) cos(β(t)) for the mobile device 120, and output the relative velocity V(t)cos(φ(t)) or −V(t) cos(β(t)) value to the scaling module 136. The scaling module 136 converts the relative velocity data into the RF compensation M_{F}(t) as represented by the frequency correction value 206. The scaling module 136 outputs the frequency correction value 206 to the radio 126, which uses the frequency correction value 206 to modify the RF transmit frequency used for the uplink channel 142-2, and thereby correct for Doppler errors. The relative velocity operations of the velocity module 134 and the mobile device transmit frequency scaling operations of the scaling module 136 may be described in more detail with reference to FIG. 3.

FIG. 3 illustrates one embodiment of a logic diagram. FIG. 3 illustrates a logic diagram 300 showing the geometry for the fixed device 110 and the mobile device 120 as the mobile device 120 moves through a cell covered by the fixed device 110. The logic diagram 300 depicts a typical Point-to-Multipoint deployment with a stationary fixed device 110 and the mobile device 120 moving at a speed V(t) at time t in the directions indicated. Using the mobile device 120 position at time t as the reference point, the Doppler frequency shift M_{F}(t) caused by the mobility of the mobile device 120 is represented as:

$${M}_{F} ( t ) = \frac{V ( t ) \cdot cos ( φ ( t ) ) \cdot {f}_{1}}{3 \times {10}^{8}} .$$

If the mobile device 120 position at time t+T is used as the reference point, the Doppler frequency shift M_{F}(t) caused by the mobility of the mobile device 120 is represented as:

$${M}_{F} ( t ) = \frac{V ( t ) \cdot cos ( π - β ( t ) ) \cdot {f}_{1}}{3 \times {10}^{8}} = \frac{- V ( t ) \cdot cos ( β ( t ) ) \cdot {f}_{1}}{3 \times {10}^{8}}$$

The velocity module 134 of the frequency correction module 130 of the mobile device 120 uses positioning system data 202, 204 to determine the relative ranging velocity, V(t)cos(φ(t)) or −V(t)cos(β(t)), to calculate the Doppler frequency shift M_{F}(t). The velocity module 134 then calculates the mobile device-to-fixed device relative velocity value.

In order for the velocity module 134 to calculate the speed V(t), it needs the static fixed device position information 202 (X, Y Z). The position module 132 of the frequency correction module 130 may update the mobile device position information 204 periodically with period T and at a rate fast enough to approximate a location for the mobile device 120 in a piece-wise linear manner during the period T. The location for the mobile device 120 is represented by (x(t), y(t), z(t)) at time t and by (x(t+T), y(t+T), z(t+T)) at time t+T. From this physical location information, the mobile device 120 shall be able to calculate its speed as:

$$V ( t ) = \frac{\sqrt{( x ( t + T ) - {x ( t )}^{2} + {( y ( t + T ) - t ( t ) )}^{2} + {( z ( t + T ) - z ( t ) )}^{2}}}{T} .$$

The velocity module 134 calculates cos(φ(t)), cos(β(t)) from the geometry A(t), B(t) and C(t) which represent the distances of a triangle. Using (A(t), B(t), C(t)), the cos(φ(t)), cos(β(t)) can be calculated using the cosine law as follows:

$$cos ( φ ( t ) ) = \frac{{A ( t )}^{2} + {B ( t )}^{2} - {C ( t )}^{2}}{2 A ( t ) \cdot B ( t )}$$

$$cos ( β ( t ) ) = \frac{{B ( t )}^{2} + {C ( t )}^{2} - {A ( t )}^{2}}{2 B ( t ) \cdot C ( t )}$$

Since the mobile device 120 knows the physical location of the fixed device 110 and its own physical locations at different times, it can calculate (A(t), B(t), C(t)) as follows:

$$A ( t ) = \sqrt{{( X - x ( t ) )}^{2} + {( Y - y ( t ) )}^{2} + {( Z - z ( t ) )}^{2}}$$

$$B ( t ) = \sqrt{{( x ( t + T ) - x ( t ) )}^{2} + {( y ( t + T ) - y ( t ) )}^{2} + {( z ( t + T ) - z ( t ) )}^{2}}$$

$$C ( t ) = \sqrt{{( X - x ( t + T ) )}^{2} + {( Y - y ( t + T ) )}^{2} + {( Z - z ( t + T ) )}^{2}}$$

A sample Doppler shift calculation may as performed by the frequency correction module 130 may be described as follows. Let the stationary location of the fixed device 110 be at (X,Y,Z) in meters, and let the location of the mobile device 120 at time t in seconds be (x(t),y(t),z(t)), where x(t)=X+500, y(t)=Y and z(t)=Z as depicted in FIG. 3. Assume the mobile device 120 is located directly east of the fixed device 110. Further assume the mobile device 120 is traveling in a south east direction at a speed of approximately 350 kilometers per hour (km/hr) or approximately 100 meters per second (m/s), and the signal center frequency is at 3.5 Gigahertz (GHz). The position module 132 provides a location update for every 0.1 s (T=0.1 s), and therefore the location of the mobile device 120 at time t+0.1 s becomes (x(t+0.1),y(t+0.1), z(t+0.1)), where

x(t+0.1)=x(t)+7=X+507,y(t+0.1)=y(t)−7=Y−7,z(t+0.1)=z(t)=Z.

The first operation is to calculate the Doppler shift, which is represented herein as:

$${M}_{F} ( t ) = \frac{V ( t ) \cdot cos ( φ ( t ) ) \cdot {f}_{1}}{3 \times {10}^{8}}$$

$$or$$

$${M}_{F} ( t ) = \frac{- V ( t ) \cdot cos ( β ( t ) ) \cdot {f}_{1}}{3 \times {10}^{8}}$$

where f₁=3.5 GHz. The next operation is to calculate V(t), cos(φ(t)), cos(β(t)). First, V(t) can be calculated as:

$$\begin{matrix}V ( t ) = \frac{\sqrt{( x ( t + T ) - {x ( t )}^{2} + {( y ( t + T ) - y ( t ) )}^{2} + {( z ( t + T ) - z ( t ) )}^{2}}}{T} \\ = \frac{\sqrt{{7}^{2} + {7}^{2} + 0}}{0.1} \\ = 99 \text{m/s}\end{matrix}$$

Next, the cos(φ(t)), cos(β(t)) can be calculated as:

$$cos ( φ ( t ) ) = \frac{{A ( t )}^{2} + {B ( t )}^{2} - {C ( t )}^{2}}{2 A ( t ) \cdot B ( t )}$$

$$cos ( β ( t ) ) = \frac{{B ( t )}^{2} + {C ( t )}^{2} - {A ( t )}^{2}}{2 B ( t ) \cdot C ( t )}$$

where:

$$\begin{matrix}A ( t ) = \sqrt{{( X - x ( t ) )}^{2} + {( Y - y ( t ) )}^{2} + {( Z - z ( t ) )}^{2}} \\ = \sqrt{{500}^{2} + 0 + 0} \\ = 500\end{matrix}$$

$$\begin{matrix}B ( t ) = \sqrt{{( x ( t + T ) - x ( t ) )}^{2} + {( y ( t + T ) - y ( t ) )}^{2} + {( z ( t + T ) - z ( t ) )}^{2}} \\ = \sqrt{{7}^{2} + {7}^{2} + 0} \\ = 9.9\end{matrix}$$

$$\begin{matrix}C ( t ) = \sqrt{{( X - x ( t + T ) )}^{2} + {( Y - y ( t + T ) )}^{2} + {( Z - z ( t + T ) )}^{2}} \\ = \sqrt{{507}^{2} + {7}^{2} + 0} \\ = 507.05\end{matrix}$$

$$and$$

$$\begin{matrix}cos ( φ ( t ) ) = \frac{{500}^{2} + {9.9}^{2} - {507.05}^{2}}{2 \times 500 \times 9.9} \\ = - 0.7072\end{matrix}$$

$$\begin{matrix}cos ( β ( t ) ) = \frac{{9.9}^{2} + {507.05}^{2} - {500}^{2}}{2 \times 9.9 \times 507.05} \\ = 0.7119\end{matrix}$$

Finally, the Doppler shift caused by the motion of the mobile device 120 is generated as follows:

$$\begin{matrix}{M}_{F} ( t ) = \frac{V ( t ) \cdot cos ( φ ( t ) ) \cdot {f}_{1}}{3 \times {10}^{8}} \\ = \frac{99 \times ( - 0.7072 ) \times 3.5 \times 1000000000}{3 \times {10}^{8}} \\ = - 816.82 Hz\end{matrix}$$

$$\begin{matrix}{M}_{F} ( t ) = \frac{- V ( t ) \cdot cos ( β ( t ) ) \cdot {f}_{1}}{3 \times {10}^{8}} \\ = \frac{- 99 \times 0.7119 \times 3.5 \times 1000000000}{3 \times {10}^{8}} \\ = - 822.22 Hz\end{matrix}$$

In this case, the motion of the mobile device 120 causes the frequency reference of the received signal center frequency at the radio 126 of the mobile device 120 to be shifted 816.82 Hz or 822.22 Hz below the original signal transmitted by the radio 112 of the fixed device 110. Hence, the uplink frequency used by the mobile device 120 will be f₁−M_{F}(t)=f₁+816.82 Hz or f₁−M_{F}(t)=f₁+822.22 Hz. As shown from this example, one can use the mobile device 120 position at time x or at time x+T to perform the frequency correction calculation. It may be desirable to use the mobile device 120 position at time x+T. As T decreases, however, the difference in Doppler frequency shift will decrease as well. In the end, either position will work.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

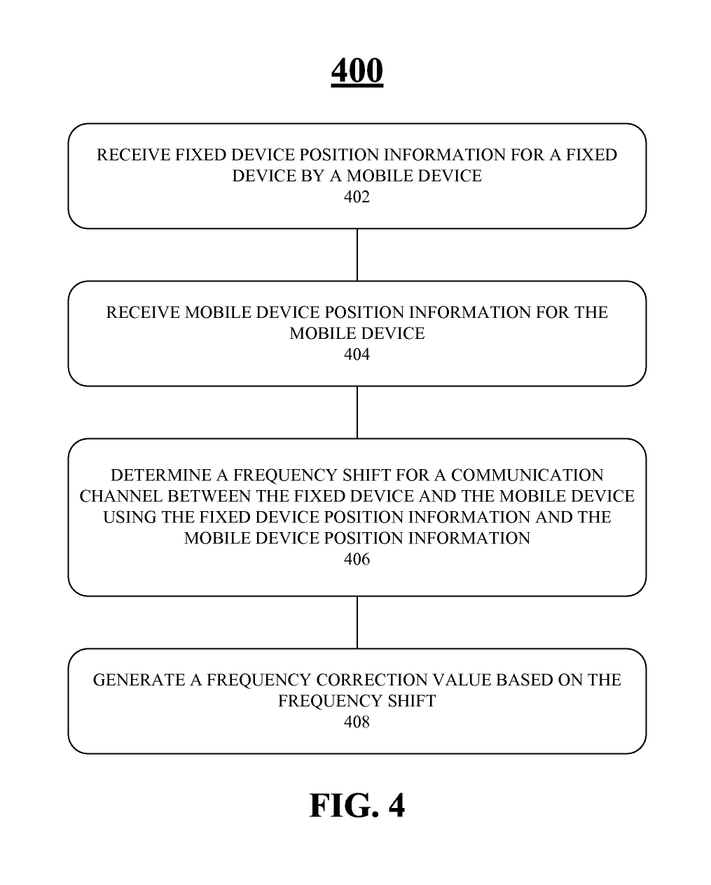

FIG. 4 illustrates one embodiment of a logic flow. FIG. 4 illustrates a logic flow 400. Logic flow 400 may be representative of the operations executed by one or more embodiments described herein. As shown in FIG. 4, the logic flow 400 may receive fixed device position information for a fixed device by a mobile device at block 402. The logic flow 400 may receive mobile device position information for the mobile device at block 404. The logic flow 400 may determine a frequency shift for a communication channel between the fixed device and the mobile device using the fixed device position information and the mobile device position information at block 406. The logic flow 400 may generate a frequency correction value based on the frequency shift at block 408. The embodiments are not limited in this context.

In one embodiment, the logic flow 400 may receive fixed device position information for a fixed device by a mobile device at block 402. For example, the velocity module 134 of the frequency correction module 130 of the mobile device 120 may receive fixed device position information 202 for the fixed device 110. The velocity module 134 may receive fixed device position information 202 from the fixed device 110. The fixed device 110 may send the fixed device position information 202 to the mobile device 120 either via a periodic broadcast or during network entry of the mobile device 120. The velocity module 134 may also receive fixed device position information 202 from a source other than the fixed device 110, such as a table or database stored in memory 124 of the mobile device 120, another network device, and so forth.

In one embodiment, the logic flow 400 may receive mobile device position information for the mobile device at block 404. For example, the velocity module 134 of the frequency correction module 130 of the mobile device 120 may receive mobile device position information 204 from the position module 132. The position module 132 of the frequency correction module 130 may update the mobile device position information 204 periodically with period T and at a rate fast enough to approximate a location for the mobile device 120 in a piece-wise linear manner during the period T.

In one embodiment, the logic flow 400 may determine a frequency shift for a communication channel between the fixed device and the mobile device using the fixed device position information and the mobile device position information at block 406. For example, the velocity module 134 may calculate the relative velocity V(t)cos(φ(t)) or −V(t)cos(β(t)) of the mobile device 120, which may be used to derive the Doppler frequency shift M_{F}(t) as caused by the mobility of the mobile device 120 as previously described with reference to FIGS. 2 and 3.

In one embodiment, the logic flow 400 may generate a frequency correction value based on the frequency shift at block 408. For example, the scaling module 136 may receive the relative velocity V(t)cos(φ(t)) or −V(t)cos(β(t)) from the velocity module 134, and generate the Doppler frequency shift M_{F}(t) as represented by the frequency correction value 206 based on the relative velocity V(t)cos(φ(t)) or −V(t)cos(β(t)) as calculated by the velocity module 134.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising a mobile device having a frequency correction module arranged to determine a frequency shift for a communication channel caused by movement of the mobile device relative to a fixed device, and generate a frequency correction value to compensate for the frequency shift.

2. The apparatus of claim 1, the frequency correction module having a position module to generate mobile device position information for the mobile device.

3. The apparatus of claim 1, the frequency correction module having a velocity module to receive fixed device position information for the fixed device and mobile device position information for the mobile device, and determine a relative velocity for the mobile device using the fixed device position information and the mobile device position information.

4. The apparatus of claim 1, the frequency correction module having a scaling module to receive a relative velocity value, and generate the frequency correction value.

5. The apparatus of claim 1, comprising a radio to connect to the frequency correction module, the radio to communicate information from the mobile device to the fixed device over a transmit frequency produced by subtracting the frequency correction value from a receive frequency for the communication channel.

6. The apparatus of claim 1, comprising a radio to connect to the frequency correction module, the radio to communicate information from the mobile device to the fixed device over a transmit frequency produced by subtracting two times the frequency correction value from a receive frequency for the communication channel for a time division duplexing system.

7. The apparatus of claim 1, comprising a radio to connect to the frequency correction module, the radio to communicate information from the mobile device to the fixed device over a transmit frequency produced by subtracting
$$\frac{{f}_{Rx}}{{f}_{Tx}}$$
times the frequency correction value from the original transmit frequency f_{Tx} for the communication channel for a frequency division duplexing system where f_{Rx} is a receive frequency at the mobile device

8. A system comprising a mobile device having:
an omni-directional antenna;
a transceiver to connect to the omni-directional antenna, the transceiver arranged to communicate information over a communication channel to a fixed device; and
a frequency correction module to connect to the transceiver, the frequency correction module arranged to determine a frequency shift for the communication channel caused by movement of the mobile device relative to the fixed device, and generate a frequency correction value to compensate for the frequency shift.

9. The system of claim 8, the fixed device comprising a base station for a cellular radiotelephone system.

10. The system of claim 8, the fixed device having a position module to provide fixed device position information for the fixed device.

11. The system of claim 8, the frequency correction module having a position module to generate mobile device position information for the mobile device.

12. The system of claim 8, the frequency correction module having a velocity module to receive fixed device position information for the fixed device and mobile device position information for the mobile device, and determine a relative velocity for the mobile device using the fixed device position information and the mobile device position information.

13. The system of claim 8, the frequency correction module having a scaling module to receive a relative velocity value, and generate the frequency correction value.

14. The system of claim 8, the transceiver to communicate information from the mobile device to the fixed device over a transmit frequency produced by subtracting the frequency correction value from a receive frequency for the communication channel.

15. The system of claim 8, the transceiver to communicate information from the mobile device to the fixed device over a transmit frequency produced by subtracting two times the frequency correction value from a receive frequency for the communication channel for a time division duplexing system.

16. The system of claim 8, the transceiver to communicate information from the mobile device to the fixed device over a transmit frequency produced by subtracting
$$\frac{{f}_{Rx}}{{f}_{Tx}}$$
times the frequency correction value from an original transmit frequency f_{Tx} for the communication channel for a frequency division duplexing system where f_{Rx} is the receive frequency at the mobile device.

17. A method, comprising:
receiving fixed device position information for a fixed device by a mobile device;
receiving mobile device position information for the mobile device;
determining a frequency shift for a communication channel between the fixed device and the mobile device using the fixed device position information and the mobile device position information; and
generating a frequency correction value based on the frequency shift.

18. The method of claim 17, comprising determining a relative velocity for the mobile device using the fixed device position information and the mobile device position information to determine the frequency shift.

19. The method of claim 17, comprising producing a transmit frequency for the mobile device by subtracting the frequency correction value from a receive frequency for the communication channel.

20. The method of claim 17, comprising producing a transmit frequency for the mobile device by subtracting two times the frequency correction value from a receive frequency for the communication channel for a time division duplexing system.

21. The method of claim 17, comprising producing a transmit frequency for the mobile device by subtracting
$$\frac{{f}_{Rx}}{{f}_{Tx}}$$
times the frequency correction value from an original planned transmit frequency f_{Tx} for the communication channel for a frequency division duplexing system with f_{Rx} being a receive frequency at the mobile device.

22. The method of claim 17, comprising sending information from the mobile device to the fixed device over the communication channel in accordance with a frequency correction value to compensate for the frequency shift.

23. An article comprising a machine-readable storage medium containing instructions that if executed enable a system to:
determine a frequency shift for a communication channel caused by movement of a mobile device relative to a fixed device; and
generate a frequency correction value to compensate for the frequency shift.

24. The article of claim 23, further comprising instructions that if executed enable the system to generate mobile device position information for the mobile device.

25. The article of claim 23, further comprising instructions that if executed enable the system to receive fixed device position information for the fixed device and mobile device position information for the mobile device, and determine a relative velocity for the mobile device using the fixed device position information and the mobile device position information.

26. The article of claim 23, further comprising instructions that if executed enable the system to:
receive a relative velocity value; and
generate the frequency correction value.

27. The article of claim 23, further comprising instructions that if executed enable the system to communicate information from the mobile device to the fixed device over the communication channel using the frequency correction value.

28. The article of claim 23, further comprising instructions that if executed enable the system to generate the mobile device position information for the mobile device using global positioning system information or triangulation information.

29. The article of claim 23, further comprising instructions that if executed enable the system to produce a transmit frequency for the mobile device by subtracting two times the frequency correction value from a receive frequency for the communication channel for a time division duplexing system.

30. The article of claim 23, further comprising instructions that if executed enable the system to produce a transmit frequency for the mobile device by subtracting
$$\frac{{f}_{Rx}}{{f}_{Tx}}$$
times the frequency correction value from an original planned transmit frequency f_{Tx} for the communication channel for a frequency division duplexing system with f_{Rx} being a receive frequency at the mobile device.
